(19) United States
(12) Patent Application Publication
(10) Pub. No.: US 2012/0095725 A1
(43) Pub. Date: Apr. 19, 2012

(54) PROGRAMMING METHOD FOR A COORDINATE MEASURING MACHINE AND COMPUTING DEVICE THEREOF

(75) Inventors: CHIH-KUANG CHANG, Tu-Cheng (TW); XIN-YUAN WU, Shenzhen City (CN); MIN WANG, Shenzhen City (CN)

(73) Assignees: HON HAI PRECISION INDUSTRY CO., LTD, Tu-Cheng (TW); HONG FU JIN PRECISION INDUSTRY (ShenZhen) CO., LTD, Shenzhen City (CN)

(21) Appl. No.: 13/221,856

(22) Filed: Aug. 30, 2011

(30) Foreign Application Priority Data
Oct. 18, 2010 (CN) 201010510454.5

(51) Int. Cl. G06F 15/00

(52) U.S. Cl. 702/150; 702/155

(57) ABSTRACT

In a programming method, a dimension system relating to a product can be embedded into a programming system. The dimension system includes measurement dimensions of measuring points of the product, and the serial numbers preset for the dimensions. The method arranges the serial numbers according to a predefined measuring path, and stores the serial numbers into a dimension list according to the order of the serial numbers presented in the measuring path. After importing the dimensions of the serial numbers into the programming system according to the presented order, the method converts each of the dimensions into a series of codes, and generates a measurement program for the dimensions according to the codes.

### BACKGROUND

1. Technical Field

Embodiments of the present disclosure generally relate to computing devices and methods for generating measurement programs, and more particularly to a programming method for a coordinate measuring machine and a computing device thereof.

2. Description of Related Art

Coordinate measuring machines (CMMs) are widely used in industry to measure manufactured parts. The measurements of the manufactured parts can determine if the manufactured parts meet design specifications and provide information for improvement in process control. Programming speed of CMMs can become a bottleneck in the measurement process. In network systems, online programming is a currently popular programming method. However, the online programming is slow, and CMMs may remain idle during programming An alternative solution is to design measurement programs for manufactured parts according to design drawings thereof, as programming with design drawings is much faster. For programming from the design drawings, a dimension system is used for importing dimensions, and an editing system is used for the programming. However, it is inconvenient for switching back and forth for programming between the dimension system and the editing system. Further, during the importing and programming process, dimension data may be mislaid or lost, and the programming process is slow. Therefore, an improved system and method is desirable to address the aforementioned issues.

### BRIEF DESCRIPTION OF THE DRAWINGS

FIG. 1 is a block diagram of one embodiment of a computing device including a dimension import unit.

FIG. 2 is a flowchart illustrating one embodiment of a programming method for a coordinate measurement machine.

FIG. 3 is a schematic diagram illustrating one example of simultaneously displaying a dimension system and a programming system on a display screen of the computing device.

FIG. 4 is a schematic diagram illustrating one example of arranging serial numbers line by line.

FIG. 5 is a schematic diagram illustrating one example of hiding serial numbers of dimensions except a current dimension that is converted into codes.

FIG. 6 is a schematic diagram illustrating one example of proportionally resizing a measuring point when a corresponding measuring dimension of the measuring point is converted into codes.

### DETAILED DESCRIPTION

In general, the word “module,” as used hereinafter, refers to logic embodied in hardware or firmware, or to a collection of software instructions, written in a programming language, such as, for example, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

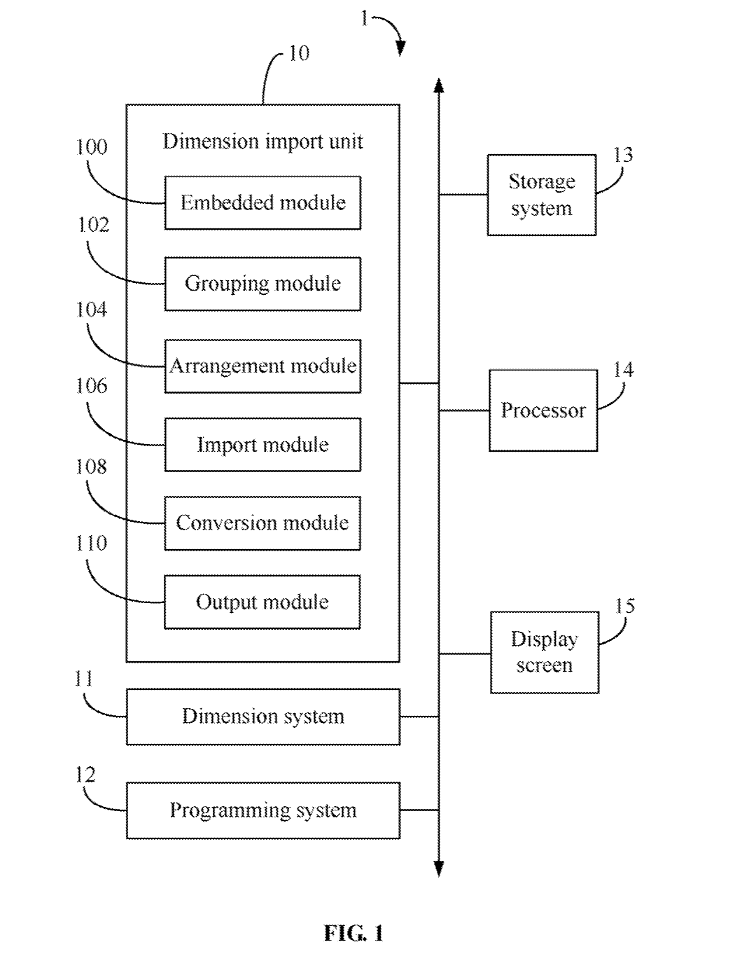

FIG. 1 is a block diagram of one embodiment of an computing device 1 including a dimension import unit 10. In the embodiment, the functions of the dimension import unit 10 are implemented by the computing device 1. The dimension import unit 10 can simultaneously display a graphical user interface (GUI) of a dimension system 11 and a GUI of a programming system 12 on a display screen 15 of the computing device 1, convert the dimensions of a product (such as a product 1000) into a series of codes, and generate a measurement program for the dimensions according to the codes. In the embodiment, the codes are program codes that are written in a programming language, such as, for example, Java, C, or assembly. The measurement program is executable by the computing device 1. The measuring program is a software program that is configured to invoke basic commands of a basic command library to measure other products of the same type of the product 1000.

In one embodiment, the computing device 1 may be a computer, a server, a portable electronic device, or any other electronic device that includes a storage system 13, at least one processor 14, and the display screen 15.

In one embodiment, the dimension import unit 10 includes an embedding module 100, a grouping module 102, a arrangement module 104, an import module 106, a conversion module 108, and an output module 110. Each of the modules 100-110 may be a software program including one or more computerized instructions that are stored in the storage system 13 and executed by the processor 14. The processor 14 may be a central processing unit or a math co-processor, for example.

In one embodiment, the storage system 13 may be a magnetic or an optical storage system, such as a hard disk drive, an optical drive, a compact disc, a digital video disc, a tape drive, or other suitable storage medium.

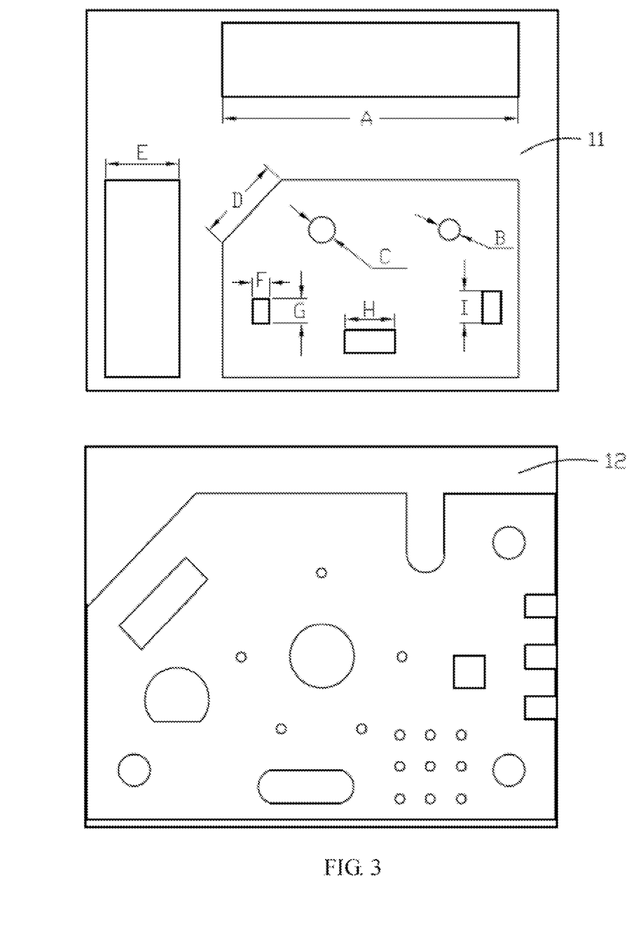

The embedding module 100 embeds the dimension system 11 of a product into the programming system 2, and simultaneously displays the dimension system 11 and the programming system 12 on the display screen 15. In the embodiment, the product may be fully represented by the dimension system 11, and dimension styles of the dimensions may include nominal scales, tolerances, map positions, and dim styles. Referring to FIG. 3, dimensions for various measuring points of the product are displayed on the GUI of the dimension system 11, and a serial number can be preset for each of the dimensions. For example, a serial number “A” represents a dimension “76.8,” a serial number “B” represents a dimension “Φ5.51,” a serial number “C” represents a dimension “Φ6.86,” a serial number “D” represents a dimension “16.36,” a serial number “E” represents a dimension “19.2,” a serial number “F” represents a dimension “4.32,” a serial number “G” represents a dimension “6.41,” a serial number “H” represents a dimension “12.96,” and a serial number “I” represents a dimension “8.35”. In another embodiment, each dimension of the product also can be displayed on the GUI of the dimension system 11.

In order to arrange the serial numbers of the dimensions in a preset sequence, the grouping module 102 groups the dimensions from one view of the product into a dimension group. For example, the dimensions in the front elevational view of the product are saved in the dimension group as shown in FIG. 3. The views which may be saved as dimension groups include a front elevational view, a rear elevational view, a left-side elevational view, a right-side elevational view, a top plan view, and a bottom plan view.

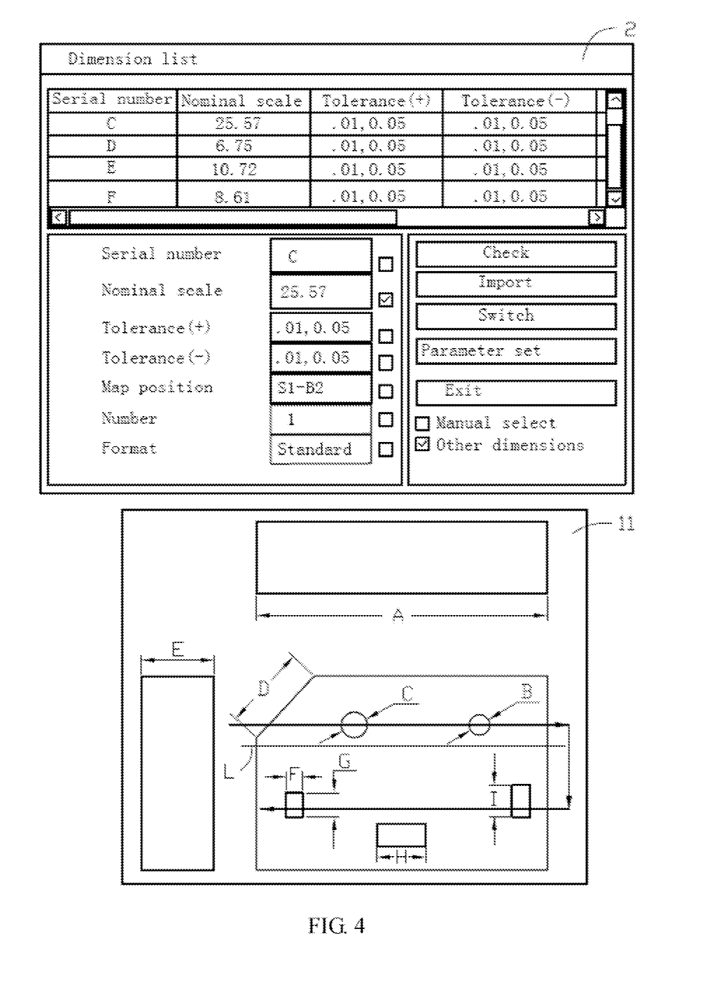

The arrangement module 104 arranges the serial numbers in the dimension group according to a sequence of measurements taken in a particular order (measuring path), and stores the serial numbers into a dimension list 2 according to an order (e.g., from left to right) of the serial numbers presented in the measuring path. In one embodiment, the measuring path can be preset as line by line that is divided into several layers for presenting or displaying the serial numbers. As shown in FIG. 4, if the front elevational view of the product is divided into two layers, the arrangement module 104 can store the serial numbers into the dimension list 2 according to an order (hereinafter referred to as “presented order”) as “D→C→B→I→H→G→F”. If the front elevational view of the product is divided into three layers, for example, the serial numbers in a first layer would include “D”, “C” and “B”, the serial numbers in a second layer would include “I”, “G” and “F”, and the serial numbers in a third layer would include “H”, the arrangement module 104 can store the serial numbers into the dimension list 2 according to the presented order as “D→C→B→I→G→F→H”.

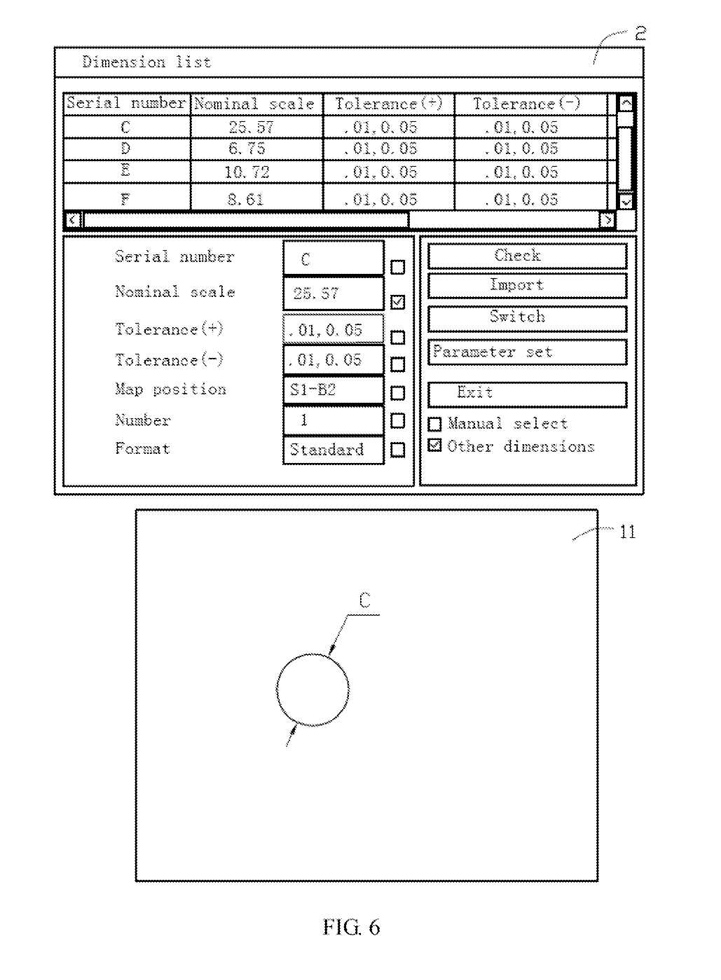

In another embodiment, a format of the dimension list 2 is not limited to the format as shown in FIG. 4 and FIG. 6, which only show a part of the dimensions and the corresponding serial numbers. From the dimension list 2, the dimensions can be seen and judged for correctness. If any dimension is wrong, the dimension can be revised by a parameter setting key in the dimension list 2.

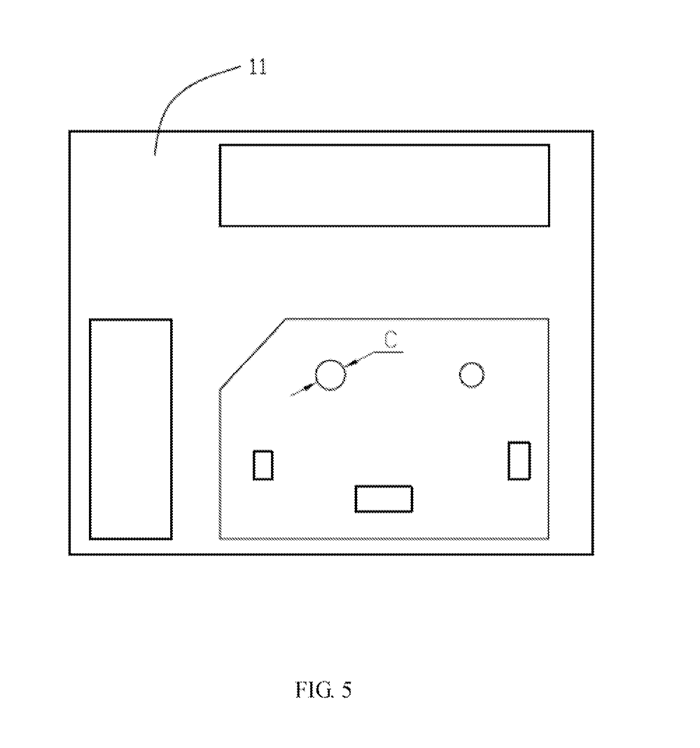

The import module 106 imports the dimensions of the serial numbers in the dimension list 2 into the programming system 12 according to the presented order. The conversion module 108 converts each of the dimensions into a series of codes. During the conversion process, the serial numbers of the dimensions except for a current dimension is hidden. For example, as shown in FIG. 5, if the dimension of the serial number “C” is the current dimension, the conversion module 108 hides all of the serial numbers of the dimensions except the serial number “C”. The conversion module 108 further proportionally resizes the measuring point corresponding to the serial number “C”, and displays the resized measuring point concerning the serial number “C” in the dimension system 11.

The output module 110 generates a measurement program for the dimensions according to the codes, and outputs the measurement program for display. In the embodiment, if a measuring point is selected, for example, if a user manually selects the measuring point having the serial number “C”, as shown in FIG. 6, the output module 110 further displays a graph corresponding to the measuring point. The graph may include a point, a line, a circle, or a plane.

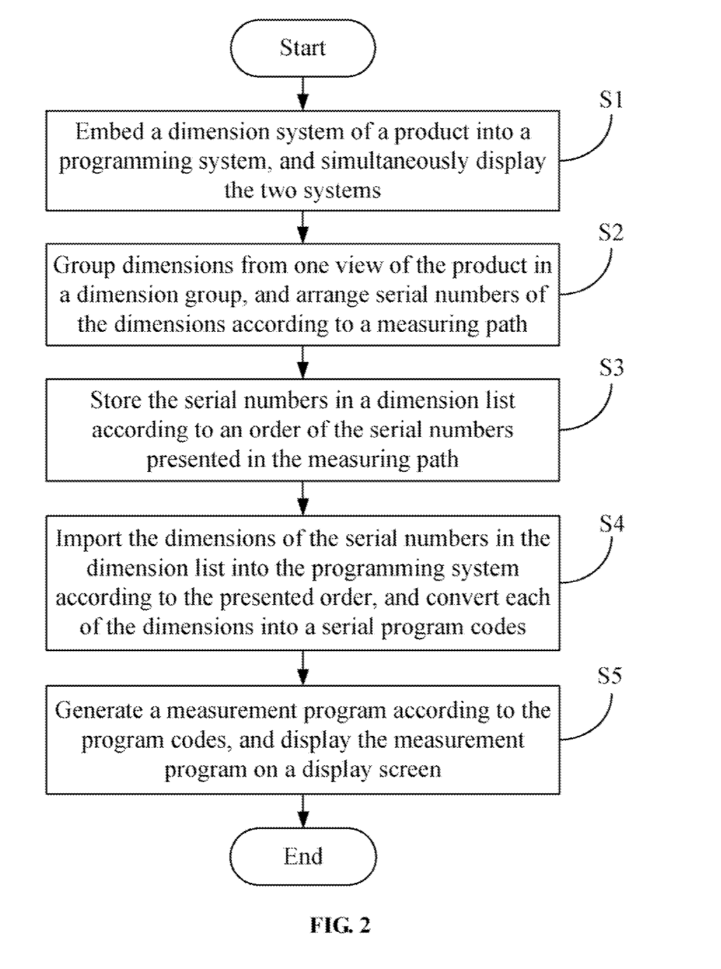

FIG. 2 is a flowchart illustrating one embodiment of a programming method for a coordinate measurement machine. The method can be performed by execution of a computer-readable program by at least one processor 11 of the data processing device 1. Depending on the embodiment, in FIG. 2, additional blocks may be added, others removed, and the ordering of the blocks may be changed.

In block S1, the embedding module 100 embeds the dimension system 11 of a product into the programming system 2, and simultaneously displays the dimension system 11 and the programming system 12 on the display screen 15. In the embodiment, the product may be represented by the dimension system 11. Referring to FIG. 3, the dimension system 11 includes the dimensions of various measuring points of the product, and the serial numbers preset for the dimensions. Dimension styles of the dimensions may include nominal scales, tolerances, map positions, and dim styles.

In block S2, the grouping module 102 groups all the dimensions from one particular view of the product into a dimension group, and the arrangement module 104 arranges the serial numbers in the dimension group according to a predefined measuring path that is divided into several layers for the arrangement of the serial numbers. In one embodiment, the measuring path can be preset as line by line. The possible views include a front elevational view, a rear elevational view, a left-side elevational view, a right-side elevational view, a top plan view, and a bottom plan view.

In block S3, the arrangement module 104 stores the serial numbers into a dimension list 2 according to an order (e.g., from left to right) of the serial numbers presented in the measuring path. As shown in FIG. 4, if the front elevational view of the product is divided into two layers, the arrangement module 104 can store the serial numbers into the dimension list 2 according to an order (hereinafter referred to as “presented order”) as “D→C→B→I→H→G→F”. If the front elevational view of the product is divided into three layers, for example, the serial numbers in a first layer would include “D”, “C” and “B”, the serial numbers in a second layer would include “I”, “G” and “F”, and the serial numbers in a third layer would include “H”, the arrangement module 104 can store the relevant serial numbers into the dimension list 2 according to the presented order as “D→C→B→I→G→F→H”.

In block S4, the import module 106 imports the dimensions of the serial numbers in the dimension list 2 into the programming system 12 according to the presented order, and the conversion module 108 converts each of the dimensions into a series of codes. During the conversion process, the serial numbers of the dimensions except for a current dimension is hidden, and the measuring point corresponding to the current dimension is proportionally resized.

In block S5, the output module 110 generates a measurement program for the dimensions based on the codes, and outputs a display of the measurement program. In the embodiment, if a measuring point is selected, for example, a user manually selecting the measuring point having the serial number “C”, as shown in FIG. 6, the output module 110 further displays a graph corresponding to the measuring point. The graph may include a point, a line, a circle, or a plane.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A programming method for a coordinate measurement machine using a computing device, the method comprising:
embedding a dimension system of a product into a programming system, the dimension system comprising dimensions of measuring points of the product, and serial numbers preset for the dimensions;
arranging the serial numbers according to a predefined measuring path, and storing the serial numbers into a dimension list according to an order of the serial numbers presented in the measuring path;
importing the dimensions of the serial numbers into the programming system according to the presented order;
converting each of the dimensions into a series of codes; and
generating a measurement program for the dimensions according to the codes, and outputting the measurement program to a display screen of the computing device.

2. The method as described in claim 1, further comprising:
proportionally resizing the measuring point corresponding to the dimensions upon the condition that a corresponding dimension of the measuring point is currently converted into the codes.

3. The method as described in claim 1, further comprising:
displaying a graph of the measuring point selected from the dimension system on the display screen; or
displaying the graph of the measuring point corresponding to a current dimension on the display screen.

4. The method as described in claim 1, further comprising:
grouping the dimensions from one view of the product into a dimension group, the view comprising a front elevational view, a rear elevational view, a left-side elevational view, a right-side elevational view, a top plan view, and a bottom plan view.

5. The method as described in claim 1, wherein the measuring path is pretest as a line by line path that is divided into several layers for arrangement of the serial numbers.

6. The method as described in claim 1, further comprising:
simultaneously displaying the dimension system and the programming system on the display screen.

7. The method as described in claim 1, further comprising:
hiding the serial numbers of the dimensions except a current dimension that is converted into the codes.

8. A computing device, the computing device comprising:
at least one processor;
a storage system; and
one or more modules that are stored in the storage system and executed by the at least one processor, the one or more modules comprising:
an embedding module operable to embed a dimension system of a product into a programming system, the dimension system comprising dimensions of measuring points of the product, and serial numbers preset for the dimensions;
an arrangement module operable to arrange the serial numbers according to a predefined measuring path, and store the serial numbers into a dimension list according to an order of the serial numbers presented in the measuring path;
an import module operable to import the dimensions of the serial numbers into the programming system according to the presented order;
a conversion module operable to convert each of the dimensions into a series of codes; and
an output module operable to generate a measurement program of the dimensions, and display the measurement program on a display screen of the computing device.

9. The computing device as described in claim 8, wherein the conversion module is further operable to proportionally resizing the measuring point corresponding to the dimensions upon the condition that a corresponding dimension of the measuring point is currently converted into the codes.

10. The computing device as described in claim 8, wherein the output module is further operable to:
displaying a graph of the measuring point selected from the dimension system on the display screen; or
displaying the graph of the measuring point corresponding to a current dimension on the display screen.

11. The computing device as described in claim 8, further comprising a grouping module operable to group the dimensions from one view of the product into a dimension group, the view comprising a front elevational view, a rear elevational view, a left-side elevational view, a right-side elevational view, a top plan view, and a bottom plan view.

12. The computing device as described in claim 8, wherein the measuring path is pretest as a line by line path that is divided into several layers for arrangement of the serial numbers.

13. The computing device as described in claim 8, wherein the embedding module is further operable to simultaneously display the dimension system and the programming system on the display screen.

14. The computing device as described in claim 8, wherein the conversion module is further operable to hide the serial numbers of the dimensions except a current dimension that is converted into the codes.

15. A non-transitory storage medium having stored thereon instructions that, when executed by a processor of a computing device, causes the processor to perform a programming method for a coordinate measurement machine, the method comprising:
embedding a dimension system of a product into a programming system, the dimension system comprising dimensions of measuring points of the product, and serial numbers preset for the dimensions;
arranging the serial numbers according to a predefined measuring path, and storing the serial numbers into a dimension list according to an order of the serial numbers presented in the measuring path;
importing the dimensions of the serial numbers into the programming system according to the presented order;
converting each of the dimensions into a series of codes; and
generating a measurement program for the dimensions according to the codes, and outputting the measurement program to a display screen of the computing device.

16. The non-transitory storage medium as described in claim 15, wherein the method further comprises:
proportionally resizing the measuring point corresponding to the dimensions upon the condition that a corresponding dimension of the measuring point is currently converted into the codes.

17. The non-transitory storage medium as described in claim 15, wherein the method further comprises:
displaying a graph of the measuring point selected from the dimension system on the display screen; or
displaying the graph of the measuring point corresponding to a current dimension on the display screen.

18. The non-transitory storage medium as described in claim 15, wherein the method further comprises:
grouping the dimensions from one view of the product into a dimension group, the view comprising a front elevational view, a rear elevational view, a left-side elevational view, a right-side elevational view, a top plan view, and a bottom plan view.

19. The non-transitory storage medium as described in claim 15, wherein the measuring path is pretest as a line by line path that is divided into several layers for arrangement of the serial numbers.

20. The non-transitory storage medium as described in claim 15, wherein the method further comprises:
hiding the serial numbers of the dimensions except a current dimension that is converted into the codes.
